(19) United States
(12) Patent Application Publication
(10) Pub. No.: US 2005/0227956 A1
(43) Pub. Date: Oct. 13, 2005

(54) Control of mold growth on wood

(76) Inventors: Ying Wang, West Chester, PA (US); Zhixiong Xue, Chadds Ford, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/823,234

(22) Filed: Apr. 13, 2004

(51) Int. Cl. A01N 55/02; A01N 43/54; A01N 43/64; A01N 43/78

(52) U.S. Cl. 514/184; 514/275; 514/383; 514/367; 428/292.4

(57) ABSTRACT

A composition comprising a copper compound, a quaternary ammonium compound, an alkanolamine or ammonia, a carbonate, and at least two moldicides wherein the total concentration of moldicides is a maximum of 80 mg per liter, said composition effective to prevent mold growth in pressure treated wood.

### BACKGROUND OF THE INVENTION

Due to the toxicity of the current wood preservative, chromated copper arsenate (CCA), the U.S. Environmental Protection Agency (EPA) and the wood industry agreed to phase out use of CCA in processes for preserving woods used in residential applications in the U.S. by the end of 2003. With the phasing out of CCA for use as a wood preservative, ammoniacal copper quaternary (ACQ) is becoming a leading contender to replace CCA.

Wood pressure-treated with ACQ, while showing the needed rot resistance, is prone to develop surface growth of molds during the few months of storage and warehousing between the pressure treatment and final sale. It is important to distinguish between fungicides that protect against wood-destroying fungi, such as basidiomycetes, and moldicides that suppress the surface growth of mildew, such as Aspergillus niger, penicillium funiculosum, etc. In contrast to rot resulting from fungi, mold has negligible adverse effect on the structural strength of wood. Mold does, however, adversely affect the appearance of the wood at the time of consumer purchase and use, and creates concerns over the quality of the product and potential concerns over the effects of molds, for instance, allergic reactions. It is therefore desirable to suppress mold growth for at least six months under normal warehousing conditions.

Isothiazolones, such as 4-chloro-2-methyl-isothiazolin-3-one (available from Rohm & Haas, Philadelphia Pa. as KATHON RH 287), have been used extensively as moldicides to suppress mold in acidic CCA formulations (pH about 1.6-2.7). However, as indicated by Imai in U.S. Patent/Application 2003/0031729 [at 0002] 4-chloro-2-methyl-isothiazolin-3-one is unstable in the more basic ACQ formulations, which have a typical pH of about 8-11, and decomposition can occur. The ACQ formulations also contain ethanolamine, which provides molds with a nitrogen source, allowing them to grow well on the ACQ-treated wood.

Williams et al. in U.S. Pat. No. 5,916,356 claim anti-fungal compositions containing copper and one or more fungicides containing a triazole group in which the weight ratio of the metal atom, e.g., copper, to the fungicidal compound was about 5:1 to 500:1. Goettsche et al. in U.S. Pat. No. 5,853,766 claim anti-fungal compositions containing copper, an alkanolamine, and from 0.25% to 15% by weight of a triazole compound such as cis-trans-1-[2-(2 ,4-d ichlorophenyl)-4-propyl-1,3-dioxolan-2-ylmethyl]-1H-1,2,4-triazole (hereinafter propiconazole).

It is desirable to have wood preservative formulations containing ACQ which are effective to suppress mold growth at low moldicide concentrations. The present invention provides such formulations.

### SUMMARY OF THE INVENTION

The present invention comprises a composition comprising a copper compound, a quaternary ammonium compound, an alkanolamine or ammonia, a carbonate, and at least two moldicides wherein the total concentration of moldicides is a maximum of 80 mg/kg, said composition effective to prevent mold growth in pressure treated wood.

The present invention further comprises a method of preserving wood comprising contacting pressure treated wood with the composition described above.

The present invention further comprises a method of improving an ACQ formulation for treating wood against mold comprising adding to the ACQ formulation at least two moldicides wherein the total concentration of moldicides is a maximum of 80 mg/kg.

### DETAILED DESCRIPTION

Trademarks are shown herein in upper case. Common names of moldicides are used, followed by the chemical name according to the International Union of Pure and Applied Chemists (IUPAC), where provided. The source of the names was “The Compendium of Pesticide Common Names”, accessible on the Internet at http://www.alanwood.net/pesticides/.

Although generally moldicides are considered to be a subset of fungicides, the term “moldicide” is hereinafter used to indicate moldicides that are used at concentrations effective against surface growth of mold or mildew, and “fungicide” to indicate moldicides effective against wood-destroying fungi.

The abbreviation “ACQ” is used herein and by the American Wood-Preservers Association to refer to certain wood preserving formulations containing copper, a quaternary ammonium compound, carbonate, and ammonia or ethanolamine. Two such specific formulations are ACQ-C and ACQ-D.

Specifications for ACQ-C are given in a “Proposal to include a Standard P5 in a New Section 18 the (AWPA) Standards” (dated 16 Jul. 2001). ACQ-C contains copper (as CuO), 66.7%, and alkylbenzyldimethylammonium chloride, 33.3%, subject to certain tolerances described in Subsections 18.1 and 18.2.

Specifications for ACQ-D are given in the AWPA Standard P5 (Standard for Waterborne Preservatives, 2001) Section 14 (p. 5). ACQ-D contains copper (as CuO), 66.7%, and didecylmethylammonium chloride 33.3%, subject to certain tolerances described in Subsections 14.1 and 14.2.

ACQ-C and ACQ-D are each prepared by dissolving the respective components listed above in ethanolamine or ammonia to yield solutions having a pH of from about 6 to about 11. Each also contains carbonate, e.g., by the inclusion of ammonium bicarbonate, to facilitate solution. The term “ACQ concentrate” is used herein to describe the concentrated mixture, which is diluted with water before application to wood.

The present invention comprises formulations of at least two moldicides, in admixture with the wood preservative ACQ, to control unwanted growth of molds on pressure treated wood. It has been found that a total moldicides concentration of from about 1 to about 80 mg/kg based on the total composition of moldicides plus ACQ, preferably from about 5 to about 60 mg/kg, and most preferably from about 10 to about 40 mg/kg provide effective control of several types of molds commonly found on wood treated with ACQ. The most desirable mixtures of moldicides are effective at the lower total moldicide concentration of equal or less than 40 mg/kg based on the total composition of moldicides plus ACQ. These compositions preferably contain a maximum moldicide concentration of about 30 mg/kg, more preferably a maximum moldicide concentration of about 20 mg/kg, more preferably a maximum moldicide concentration of about 16 mg/kg, and most preferably a maximum moldicide concentration of about 10 mg/kg.

In the practice of the present invention, the ACQ preservative solution containing at least two moldicides is prepared conventionally, for instance as described in the American Wood Preserver's Association (AWPA) Standards 2002, P5 Standard for Waterborne Preservatives. This ACQ formulation contains copper (II) ion, typically as a basic copper carbonate, quaternary ammonium compound (quat), and an alkanolamine or ammonia. Prior to the wood impregnation step, to this ACQ formulation is added at least two moldicides selected from the groups comprising the list below:
Algicides, such as nabam, disodium ethylenebis(dithiocarbamate);
Aliphatic nitrogen moldicides, such as butylamine, (RS)-sec-butylamine; cymoxanil, 1-(2-cyano-2-methoxyiminoacetyl)-3-ethylurea; dodine, 1-dodecylguanidinium acetate; and guazatine, (guazatine has no formal name, a mixture of products resulting from the amidination of technical iminodi(octamethylene)diamine, containing numerous guanidines and polyamines);
Amide moldicides, such as carpropamid, a mixture of (1R,3S)-2,2-dichloro-N—[(R)-1-(4-chlorophenyl)ethyl]-1-ethyl-3-methylcyclopropanecarboxamide, (1S,3R)-2,2-dichloro-N—[(R)-1-(4-chlorophenyl)ethyl]-1-ethyl-3-methylcyclopropanecarboxamide, (1S,3R)-2,2-dichloro-N—[(S)-1-(4-chlorophenyl)ethyl]-1-ethyl-3-methylcyclopropanecarboxamide and (1R,3S)-2,2-dichloro-N—[(S)-1-(4-chlorophenyl)ethyl]-1-ethyl-3-methylcyclopropanecarboxamide where the first two cited comprise at least 95% of the total; diclocymet, (RS)-2-cyano-N—[(R)-1-(2,4-dichlorophenyl)ethyl]-3,3-dimethylbutyramide; and ethaboxam, (RS)—N-(alpha-cyano-2-thenyl)-4-ethyl-2-(ethylamino)-1,3-thiazole-5-carboxamide (hereinafter ethaboxam);
Acylamino acid moldicides, such as benalaxyl, methyl N-(phenylacetyl)-N-(2,6-xylyl)-DL-alaninate; and metalaxyl, methyl N-(methoxyacetyl)-N-(2,6-xylyl)-DL-alaninate;
Benzamide moldicides, such as benzohydroxamic acid, and tioxymid, 5-isothiocyanato-2-methoxy-N,N-dimethyl-m-toluamide;
Furamide moldicides, such as cyclafuramid, N-cyclohexyl-2,5-dimethyl-3-furamide; and furmecyclox, methyl N-cyclohexyl-2,5-dimethyl-3-furohydroxamate;
Phenylsulfamide moldicides, such as dichlofluanid, N-dichlorofluoromethylthio-N′, N′-dimethyl-N-phenylsulfamide; and tolylfluanid, N-dichlorofluoromethylthio-N′,N′-dimethyl-N-p-tolylsulfamide;
Valinamide moldicides, such as benthiavalicarb, [(S)-1-{[(1R)-1-(6-fluoro-1,3-benzothiazol-2-yl)ethyl]carbamoyl}-2-methylpropyl]carbamic acid; and iprovalicarb, isopropyl 2-methyl-1-[(1-p-tolylethyl)carbamoyl]-(S)-propylcarbamate;
Anilide moldicides, such as boscalid, 2-chloro-N-(4′-chlorobiphenyl-2-yl)nicotinamide; carboxin, 5,6-dihydro-2-methyl-1,4-oxathiine-3-carboxanilide (hereinafter carboxin); and metsulfovax, 2,4-dimethyl-1,3-thiazole-5-carboxanilide;
Benzanilide moldicides, such as flutolanil, alpha,alpha,alpha-trifluoro-3′-isopropoxy-o-toluanilide; salicylanilide; and tecloftalam, 2′,3,3′,4,5,6-hexachlorophthalanilic acid;
Furanilide moldicides, such as fenfuram, 2-methyl-3-furanilide; and furalaxyl, methyl N-(2-furoyl)-N-(2,6-xylyl)-DL-alaninate;
Sulfonanilide moldicides, such as flusulfamide, 2′,4-dichloro-alpha,alpha,alpha-trifluoro-4′-nitro-m-toluenesulfonanilide;
Antibiotic moldicides, such as aureofungin, there is no chemical name for aureofungin, the registry numbers for aureofungin is 806541-6, aureofungin A is 6327845-5, and aureofungin B is 63278444; cycloheximide, 4-{(2R)-2-[(1S,3S,5S)-3,5-dimethyl-2-oxocyclohexyl]-2-hydroxyethyl}piperidine-2,6-dione; and polyoxins, no chemical name exists for polyoxins, the registry number is 11113-80-7;
Strobilurin moldicides, such as azoxystrobin, methyl (E)-2-{2-[6-(2-cyanophenoxy)pyrimidin-4-yloxy]phenyl}-3-methoxyacrylate (hereinafter azoxystrobin); and dimoxystrobin. (E)-2-(methoxyimino)-N-methyl-2-[alpha-(2,5-xylyloxy)-o-tolyl]acetamide;
Aromatic moldicides, such as chlorothalonil, tetrachloroisophthalonitrile; and dicloran, 2,6-dichloro-4-nitroaniline;
Benzimidazole moldicides, such as carbendazim, methyl benzimidazol-2-ylcarbamate (hereinafter carbendazim); and thiabendazole, 2-(thiazol-4-yl)benzimidazole;
Benzimidazole precursor moldicides, such as furophanate, methyl 4-(2-furfurylideneaminophenyl)-3-thioallophanate (hereinafter furophanate); thiophanate, diethyl 4,4′-(o-phenylene)bis(3-thioallophanate); and benomyl, methyl 1-(butylcarbamoyl)benzimidazol-2-ylcarbamate (hereinafter benomyl);
Benzothiazole moldicides, such as chlobenthiazone, 4-chloro-3-methyl-1,3-benzothiazol-2(3H)-one; and TCMBT, 2-(thiocyanomethylthio)benzothiazole;
Bridged diphenyl moldicides, such as bithionol, 2,2′-thiobis(4,6-dichlorophenol); and diphenylamine;
Carbamate moldicides, such as benthiavalicarb, see valinamide moldicides above; and furophanate, see benzimidazole precursor moldicides above;
Benzimidazolylcarbamate moldicides, such as cypendazole, methyl 1-(5-cyanopentylcarbamoyl)benzimidazol-2-ylcarbamate; and debacarb, 2-(2-ethoxyethoxy)ethyl benzimidazol-2-ylcarbamate;
Carbanilate moldicides, such as diethofencarb, isopropyl 3,4-diethoxycarbanilate;
Conazole moldicides (imidazoles), such as prochloraz, N-propyl-N-[2-(2,4,6-trichlorophenoxy)ethyl]imidazole-1-carboxamide; and triflumizole, (E)-4-chloro-alpha,alpha,alpha-trifluoro-N-(1-imidazol-1-yl-2-propoxyethylidene)-o-toluidine;
Conazole moldicides (triazoles), such as cyproconazole, (2RS, 3RS;2RS, 3SR)-2-(4-chlorophenyl)-3-cyclopropyl-1-(1H-1,2,4-triazol-1-yl)butan-2-ol; flusilazole, bis(4-fluorophenyl)(methyl)(1H-1,2,4-triazol-1-ylmethyl)silane; triadimefon, (RS)-1-(4-chlorophenoxy)-3,3-dimethyl-1-(1H-1,2,4-triazol-1-yl)butan-2-one;
triadimenol (BAYTAN) is (1RS,2RS; 1RS,2SR)-1-(4-chlorophenoxy)-3,3-dimethyl-1-(1H-1,2,4-triazol-1-yl)butan-2-ol, hereinafter BAYTAN; and tebuconazole, (RS)-1-p-chlorophenyl-4,4-dimethyl-3-(1H-1,2,4-triazol-1-ylmethyl)pentan-3-ol;
Dicarboximide moldicides, such as famoxadone, (RS)-3-anilino-5-methyl-5-(4-phenoxyphenyl)-1,3-oxazolidine-2,4-dione; and fluoroimide, 2,3-dichloro-N-4-fluorophenylmaleimide;
Dichlorophenyl dicarboximide moldicides, such as iprodione, 3-(3,5-dichlorophenyl)-N-isopropyl-2,4-dioxoimidazolidine-1-carboxamide, (hereinafter iprodione); and vinclozolin, (RS)-3-(3,5-dichlorophenyl)-5-methyl-5-vinyl-1,3-oxazolidine-2,4-dione;
Phthalimide moldicides, such as CAPTAN, N-(trichloromethylthio)cyclohex-4-ene-1,2-dicarboximide; and folpet, N-(trichloromethylthio)phthalimide;
Dinitrophenol moldicides, such as dinocap, 2,6-dinitro-4-octylphenyl crotonates and 2,4-dinitro-6-octylphenyl crotonates in which “octyl” is a mixture of 1-methylheptyl, 1-ethylhexyl and 1-propylpentyl groups; and dinoterbon, 2-tert-butyl4,6-dinitrophenyl ethyl carbonate;
Dithiocarbamate moldicides, such as ferbam, iron(III) dimethyldithiocarbamate (hereinafter ferbam); and ziram, zinc bis(dimethyldithiocarbamate);
Cyclic dithiocarbamate moldicides, such as dazomet, 3,5-dimethyl-1,3,5-thiadiazinane-2-thione; and etem, 5,6-dihydro-(3H)-imidazo[2,1-c]-1,2,4-dithiazole-3-thione;
Polymeric dithiocarbamate moldicides, such as maneb, manganese ethylenebis(dithiocarbamate) (polymeric); and zineb, zinc ethylenebis(dithiocarbamate) (polymeric);
Imidazole moldicides, such as cyazofamid, 4-chloro-2-cyano-N,N-dimethyl-5-p-tolylimidazole-1-sulfonamide; and fenamidone (S)-1-anilino-4-methyl-2-methylthio-4-phenylimidazolin-5-one;
Inorganic moldicides, such as sodium azide and sulfur;
Morpholine moldicides, such as fenpropimorph, (RS)-cis-4-[3-(4-tert-butylphenyl)-2-methylpropyl]-2,6-dimethylmorpholine; and flumorph, (EZ)-4-[3-(3,4-dimethoxyphenyl)-3-(4-fluorophenyl)acryloyl]morpholine, (50% (E)-isomer, 50% (Z)-isomer);
Oxazole moldicides, such as chlozolinate, ethyl (RS)-3-(3,5-dichlorophenyl)-5-methyl-2,4-dioxo-1,3-oxazolidine-5-carboxylate; and vinclozolin, see dichlorophenyl dicarboximide moldicides above;
Phthalimide moldicides, such as captifol, N-(1,1,2,2-tetrachloroethylthio)cyclohex-4-ene-1,2-dicarboximide
Polysulfide moldicides, such as barium polysulfide and calcium polysulfide;
Pyridine moldicides, such as fluazinam, 3-chloro-N-(3-chloro-5-trifluoromethyl-2-pyridyl)-alpha,alpha,alpha-trifluoro-2,6-dinitro-p-toluidine (hereinafter fluazinam); and pyridinitril, 2,6-dichloro-4-phenylpyridine-3,5-dicarbonitrile;
Pyrimidine moldicides, such as bupirimate, 5-butyl-2-ethylamino-6-methylpyrimidin-4-yl dimethylsulfamate; and cyprodinil, 4-cyclopropyl-6-methyl-N-phenylpyrimidin-2-amine;
Pyrrole moldicides, such as fenpiclonil, 4-(2,3-dichlorophenyl)pyrrole-3-carbonitrile; and fludioxonil, 4-(2,2-difluoro-1,3-benzodioxol-4-yl)pyrrole-3-carbonitrile;
Quinoline moldicides, such as ethoxyquin, 1,2-dihydro-2,2,4-trimethylquinolin-6-yl ethyl ether; and 8-hydroxyquinoline sulfate, bis(8-hydroxyquinolinium)sulfate (hereinafter 8-hydroxyquinoline);
Quinone moldicides, such as benquinox, 2′-(4-hydroxyiminocyclohexa-2,5-dienylidene)benzohydrazide; and chloranil, tetrachloro-p-benzoquinone;
Quinoxaline moldicides, such as chinomethionat, 6-methyl-1,3-dithiolo[4,5-b]quinoxalin-2-one; and chlorquinox, 5,6,7,8-tetrachloroquinoxaline;
Thiazole moldicides, such as etridiazole, ethyl 3-trichloromethyl-1,2,4-thiadiazol-5-yl ether; and thiabendazole, see benzimidazole moldicides above;
Thiocarbamate moldicides, such as methasulfocarb, S-4-methylsulfonyloxyphenyl methylthiocarbamate; and prothiocarb, S-ethyl (3-dimethylaminopropyl)thiocarbamate;
Thiophene moldicides, such as ethaboxam, see amide moldicides above; and silthiofam, N-allyl-4,5-dimethyl-2-(trimethylsilyl)thiophene-3-carboxamide;
Triazine moldicides, such as anilazine, 4,6-dichloro-N-(2-chlorophenyl)-1,3,5-triazin-2-amine;
Triazole moldicides, such as bitertanol, 1-(biphenyl-4-yloxy)-3,3-dimethyl-1-(1 H-1,2,4-triazol-1-yl)butan-2-ol (20:80 ratio of (1RS,2RS)- and (1RS,2SR)-isomers); and fluotrimazole, 1-(3-trifluoromethyltrityl)-1H-1,2,4-triazole;
Urea moldicides, such as bentaluron, 1-(1,3-benzothiazol-2-yl)-3-isopropylurea; and pencycuron, 1-(4-chlorobenzyl)-1-cyclopentyl-3-phenylurea;
Others, such as zinc naphthenate, SODIUM OMADINE, 2(1H)-pyridinethione, 1-hydroxy-, sodium salt; and ZINC OMADINE, zinc, bis(1-hydroxy-2(1H)-pyridinethionato)-;
Preferred for use herein are compositions wherein at least one moldicide contains a triazole group. A suitable triazole compound is any compound which contains a triazole group and which possesses moldicidal activity. Preferably the triazole compound contains the triazole group:

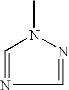

Advantageously, the triazole compound is selected from compounds of formula (A): 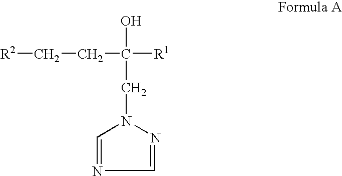
wherein R¹ represents a branched or straight chain C₁-C₅ alkyl group (e.g., t-butyl) and R² represents a phenyl group optionally substituted by one or more substituents equal to halogen (e.g., chlorine, fluorine or bromine), C₁-C₃ alkyl (e.g., methyl), C₁-C₃ alkoxy (e.g., methoxy), phenyl, or nitro groups. A particularly preferred compound of Formula A is (RS)-1-p-chlorophenyl-4,4-dimethyl-3-(1H-1,2,4-triazol-1-ylmethyl)pentan-3-ol, hereinafter “tebuconazole”.

Alternatively, the triazole compound is advantageously selected from compounds of Formula B: 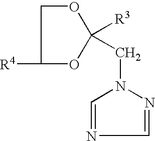
wherein R³ is as defined for R² above and R⁴ represents a hydrogen atom or a branched or straight chain C₁-C₅ alkyl group. A particularly preferred compound of Formula B is cis-trans-1-[2-(2,4-dichlorophenyl)-4-propyl-1,3-dioxolan-2-ylmethyl]-1H-1,2,4-triazole, hereinafter “propiconazole”. It has been found that moldicides such as propiconazole; tebuconazole; 4-cyclopropyl-6-methyl-N-phenylpyrimidin-2-amine (hereinafter cyprodinil); and 2-(thiocyanomethylthio)benzothiazole (hereinafter TCMBT) are especially preferred for use herein. Mixtures of moldicides containing propiconazole and one or more of the group comprising tebuconazole, cyprodinil, or TCMBT are especially effective at the low total moldicide concentration of 40 mg/kg or less.

The term “composition” is used herein to describe the composition of the present invention, comprising a copper compound, a quaternary ammonium compound, an alkanolamine or ammonia, a carbonate, and at least two moldicides wherein the total concentration of moldicides is a maximum of 80 mg/kg. Thus the composition contains ACQ plus at least two moldicides. Such a composition is ready to use on a wood substrate and is effective in preventing mold growth in pressure treated wood. In the compositions of the present invention, the weight ratio of copper (as the element) to total moldicide is greater than 500:1.

The term “moldicide concentrate” is used herein to describe a solution or emulsion containing two or more moldicides present in higher concentrations of from about 1% to about 50% by weight, and preferably from about 5% to about 40% by weight, with out the ACQ components. The moldicide concentrate is subsequently mixed with the ACQ components (a copper compound, a quaternary ammonium compound, an alkanolamine or ammonia, and a carbonate) and diluted to provide the composition of the present invention. Such moldicide concentrates provide economies in shipping and storage. For instance, a 40% concentrate is diluted 20000-fold to provide a 20 mg/kg composition.

In a first embodiment, the compositions of the present invention are prepared in a single mixing procedure wherein the ACQ components (the copper compound, the quaternary ammonium compound, the alkanolamine or ammonia, and carbonate) are combined with at least two moldicides. The total concentration of moldicides is adjusted to a maximum of 80 mg/kg. Typically, the moldicides are added to the ACQ formulation as solids, as a moldicide concentrate in the form of a solution in a solvent, or as a moldicide concentrate in the form of an emulsion.

Methods for preparing such moldicide concentrates as solutions and emulsions are well know to those skilled in the art. Depending on the nature of the moldicides used, suitable surfactants are non-ionic, cationic and/or anionic surfactants having good emulsifying, dispersing and wetting properties. The term “surfactants” as used herein also comprises mixtures of surfactants. Such moldicide concentrates are prepared, e.g., by homogeneously mixing solvents and/or appropriate surfactants. Emulsions can typically contain from about 1% to about 50% of the moldicides. Solutions can contain a minimum of about 0.01% of the moldicide. The maximum concentration of moldicide in a solution is below the solubility limit in the solvent at the lowest temperature that the solution will encounter prior to dilution. Suitable solvents are aromatic hydrocarbons, preferably the fractions containing 8 to 12 carbon atoms such as xylene mixtures or substituted naphthalenes; phthalates such as dibutyl or dioctyl phthalate; aliphatic hydrocarbons such as cyclohexane or paraffins; alcohols and glycols and their ethers and esters such as ethanol, ethylene glycol, ethylene glycol monomethyl or monoethyl ether; ketones such as cyclohexanone; strongly polar solvents such as N-methyl-2-pyrrolidone, dimethyl sulfoxide or dimethylformamide; vegetable oils or epoxidised vegetable oils such as epoxidised coconut oil or soybean oil; and water.

In a second embodiment, the compositions of the present invention are prepared in two mixing procedures. The two or more moldicides are prepared as a moldicide concentrate in the form of an emulsion or a solution as described in the first embodiment. The concentrate is then transported, typically to the wood processing location, and there added to the ACQ formulation. The total concentration of moldicides is again adjusted to a maximum of 80 mg/kg.

In a third embodiment, an ACQ concentrate and a moldicide concentrate are prepared in the form of two concentrates intended for mixing before or after dilution. The two concentrates are again typically transported to the wood processing location, where they are combined and diluted to provide the compositions of the present invention. The total concentration of moldicides is again adjusted to a maximum of 80 mg/kg. Where means to insure complete dissolution or dispersion are limited, the dissolution of the moldicide component is facilitated by including water or a suitable water-soluble solvent as a solution aid. The composition of the invention can contain water as solvent, or an organic solvent or a mixture of solvents. A preferred example of such a solution aid is ethanol. The amount of moldicide concentrate combined with the ACQ formulation is preferably an amount sufficient to provide a treatment solution containing from about 10 to about 40 mg/kg of total moldicides. The compositions of the present invention are useful for treating pressure treated wood to control growth of mold.

The present invention further comprises a method of improving an ACQ formulation for treating wood against mold comprising adding to the ACQ formulation at least two moldicides wherein the total concentration of moldicides is a maximum of 80 mg/kg. The moldicides are combined with the ACQ formulation according to the three embodiments described above for preparing compositions of the present invention. The total amount of moldicides after combination with the ACQ is from about 1 to about 80 mg/kg, preferably from about 5 to about 60 mg/kg, more preferably from about 10 to about 40 mg/kg. The most desirable compositions contain a maximum total moldicide concentration of equal to or less than about 40 mg/kg, preferably about 30 mg/kg, more preferably about 20 mg/kg, more preferably about 16 mg.kg, and most preferably about 10 mg/kg. Preferred moldicides include cis-trans-1-[2-(2,4-dichlorophenyl)-4-propyl-1,3-dioxolan-2-ylmethyl]-1H-1,2,4-triazole(propiconazole), (RS)-1-p-chlorophenyl-4,4-dimethyl-3-(1H-1,2,4-triazol-1-ylmethyl)pentan-3-ol (tebuconazole), 4-cyclopropyl-6-methyl-N-phenylpyrimidin-2-amine (cyprodinil) and 2-(thiocyanomethylthio)benzothiazole (TCMBT). Mixtures of moldicides containing propiconazole and one or more of tebuconazole, cyprodinil, or TCMBT are especially preferred because they are effective at a total moldicide concentration less than or equal to about 40 mg/kg.

The present invention further comprises a method of preserving wood comprising contacting pressure treated wood with a composition of the present invention as described above. The compositions of the present invention are impregnated into the wood to be protected using a vacuum-pressure procedure. In a simplified description, the wood is subjected to a vacuum, exhausting air in the interstices of the wood. The wood is completely immersed in the treating solution, the vacuum is released and the treating solution is pressurized into the porous wood substrate. The wood is drained and allowed to dry under storage conditions. A standard process for vacuum impregnation for all timber products is the Preservative Treatment by Pressure Process described by the American Wood Preserver's Association (AWPA) Standards 2001, Standard C1-00.

Table 1 below shows the effectiveness of common moldicides against a panel of seven molds 10 days after inoculation. Table 1 shows individual moldicides are not always effective against all the molds tested. The Table shows the minimium concentration required to inhibit growth, or minimum inhibitory concentration (MIC), in mg/kg. The chemical name is listed following Table 1. Tests were done using the Six-well Plates Test as described below. Results shown were obtained after 10 days of incubation at room temperature and are in MIC units. Concentrations of moldicides tested were 100, 50, 10, 5 and 1 mg/kg.

The results in Table 1 showed that the various commercial moldicides have different specificity and activity against a panel of common molds. Furthermore, the table shows it would be difficult to control all of the molds with a single moldicide at a low concentration of less than 50 mg/kg.

TABLE 1
Minimum Inhibitory Concentrations (MIC) in mg/kg

| | | | | | | | | | Mold from |
|---|---|---|---|---|---|---|---|---|---|
| | | Aspergilus | Aureobasidium | | Penicillium | Alternaria | Trichoderma | Stachybotrus | ACQ wood |
| Ref. | Moldicide | niger | pullulans | cladosporioides | funiculosum | alternata | virens | charatrum | (cephalosporium?) |
| 1 | TCMBT* | NT | 300 | 30 | 30 | 300 | 3 | 3 | NT |
| 2 | 8-hydroxy- | 100 | 50 | 25 | 25 | 25 | 25 | 10 | NT |
| | quinoline | | | | | | | | |
| 3 | Azoxystrobin | >100 | >100 | >100 | >100 | >100 | >100 | 25 | NT |
| 4 | BAYTAN | >100 | 50 | 50 | >100 | >100 | >100 | >100 | NT |
| 5 | Benomyl | 10 | 100 | 1^{a} | 1 | >100 | 1 | NT | NT |
| 6 | Captafol | 10 | >100 | >100 | >100 | >100 | >100 | 25 | NT |
| 7 | Carbendazim | 5 | 0.1 | 1^{a} | 1 | >100 | 1 | NT | NT |
| 8 | Carboxin | >100 | 100 | 100 | >100 | >100 | NT | 100 | >100 |
| 9 | Cyprodinil | 10 | 100 | 100 | 100 | 10 | >100 | NT | >100 |
| 10 | FAMOXATE | >100 | >100 | >100 | >100 | >100 | >100 | >100 | NT |
| 11 | Fenpiclonil | 1 | 50 | 10 | >100 | 50 | >100 | 10 | NT |
| 12 | Fenpropimorph | >100 | 10 | 50 | >100 | 50 | 10 | 10 | NT |
| 13 | Ferbam | 100 | 100 | 100 | >100 | >100 | >100 | 50 | NT |
| 14 | Fluazinam | 1 | 1 | 1 | 10 | 10 | >100 | NT | NT |
| 15 | Tebuconazole | 10 | 10 | 10 | >10 | 100 | >10 | NT | >100 |
| 16 | Iprodione | 10 | >100 | >101 | >102 | 100 | >100 | NT | NT |
| 17 | Nabam | 100 | 100 | 100 | >100 | >100 | 100 | 100 | NT |
| 18 | Cymoxinil | 10 | >100 | >100 | >100 | >100 | >100 | >100 | NT |
| 19 | Propiconazole | 10 | 1 | 1 | 100 | >100 | 10 | NT | 10 |
| 20 | Tridimefon | >100 | >100 | >100 | >100 | >100 | >100 | >100 | NT |

Note:
*BUSAN 30WB, 30% TCMBT formulation from Buckman Laboratories, Inc., Memphis, TN;
^{a}yellow, oily, and slow growth.
NT = not tested.
“>” means greater than

All chemicals listed in Table 1 were obtained from Chem Service, (West Chester Pa.) except where noted otherwise. The chemical identities for the common names used in Table 1 are shown below, using the IUPAC nomenclature, where provided.

1. TCMBT is 2-(thiocyanomethylthio)benzothiazole, CAS 21564-17-0, and is available from Buckman Laboratories, Inc. Memphis, Tenn.

2. 8-hydroxyquinoline is bis(8-hydroxyquinolinium) sulfate, CAS 134-31-6.

3. Azoxystrobin is methyl (E)-2-{2-[6-(2-cyanophenoxy)pyrimidin-4-yloxy]phenyl}-3-methoxyacrylate, CAS 131860-33-8.

4. BAYTAN (or triadimenol) is (1RS,2RS; 1RS,2SR)-1-(4-chlorophenoxy)-3,3-dimethyl-1-(1H-1,2,4-triazol-1-yl)butan-2-ol, CAS 55219-65-3.
5. Benomyl is methyl 1-(butylcarbamoyl)benzimidazol-2-ylcarbamate, CAS 17804-35-2.
6. Captafol is 3a,4,7,7a-tetrahydro-2-[(1,1,2,2-tetrachloroethyl)thio]-1H-isoindole-1,3(2H)-dione, CAS 2425-06-1.
7. Carbendazim is methyl benzimidazol-2-ylcarbamate, CAS 10605-21-7.
8. Carboxin is 5,6-dihydro-2-methyl-1,4-oxathiine-3-carboxanilide, CAS 5234-68-4.
9. Cyprodinil is 4-cyclopropyl-6-methyl-N-phenylpyrimidin-2-amine, CAS 121552-61-2.
10. FAMOXATE (famoxadone) is (RS)-3-anilino-5-methyl-5-(4-phenoxyphenyl)-1,3-oxazolidine-2,4-dione, CAS 131807-57-3.
11. Fenpiclonil is 4-(2,3-dichlorophenyl)-1H-pyrrole-3-carbonitrile, CAS 74738-17-3.
12. Fenpropimorph is (RS)-cis-4-[3-(4-tert-butylphenyl)-2-methylpropyl]-2,6-dimethylmorpholine, CAS 67564-91-4.
13. Ferbam is iron(III) dimethyldithiocarbamate, CAS 14484-64-1.
14. Fluazinam is 3-chloro-N-(3-chloro-5-trifluoromethyl-2-pyridyl)-alpha,alpha,alpha-trifluoro-2,6-dinitro-p-toluidine, CAS 79622-59-6.
15. Tebuconazole is (RS)-1-p-chlorophenyl4,4-dimethyl-3-(1H-1,2,4-triazol-1-ylmethyl)pentan-3-ol, CAS 107534-96-3.
16. Iprodione is 3-(3,5-dichlorophenyl)-N-isopropyl-2,4-dioxoimidazolidine-1-carboxamide, CAS 36734-19-7.
17. Nabam is disodium ethylenebis(dithiocarbamate), CAS 142-59-6.
18. Cymoxanil is 1-(2-cyano-2-methoxyiminoacetyl)-3-ethylurea, CAS 57966-95-7.
19. Propiconazole is cis-trans-1-[2-(2,4-dichlorophenyl)-4-propyl-1,3-dioxolan-2-ylmethyl]-1H-1,2,4-triazole, CAS 60207-90-1.
20. Tridimefon is (RS)-1-(4-chlorophenoxy)-3,3-dimethyl-1-(1H-1,2,4-triazol-1-yl)butan-2-one, CAS 4312143-3.
   Test Methods

1. Six-Well Plate Screening Test

A laboratory screen based on 6-well plate and nutrient medium was used to test moldicides against several common molds. Malt Extract Agar (available from Becton Dickinson Microbiology System, Sparks, Md.) was autoclaved and kept at 60° C. until use. Twenty 15-mL Corning centrifuge tubes were used for each compound tested. Sterile plastic inoculation loops and Corning Costar 3516 6-well cell culture plates were used for inoculation and mold growth.

The molds tested were from the American Type Culture Collection (ATCC, Bethesda Md.): Trichoderma virens, ATCC 9645; Penicillium funiculosum, ATCC 11797; Aureobasidium pullulans, ATCC 7305; Alternaria alternata, ATCC 16086; Cladosporium cladosporoides, ATCC 6721; Aspergillus niger, ATCC 64045; Stachybotrus charatrum, ATCC 9182; and Mold from ACQ-treated wood. The mold from ACQ-treated wood was believed to be a cephalosporium. It is commonly found on ACQ-treated wood and was included since it is likely resistant to the moldicidal effects of ACQ.

The procedure for screening the moldicide potential of compounds was as follows. The compound (10 mg) was weighed and dissolved in 1 mL of solvent (dimethylsulfoxide or deionized water), depending on the solubility characteristics of the compound, to make a 10,000 mg/kg stock solution. The stock solution was diluted tenfold (100 microL into 900 microL) in the same solvent three times to give 1000, 100, and 10 mg/kg solutions. The dilution scheme was appropriately revised so that the final concentrations were the same if the solute was not soluble at 10 mg/mL. Four 15-mL tubes and one 6-well cell culture plate for each mold to be tested were set up and labeled (20 total tubes and five plates per compound). The chemical solution was added to tubes as follows, (a) 80 microL 10,000 mg/kg solution to tube 1, (b) 80 microL 1000 mg/kg solution to tube 2, (c) 80 microL 100 mg/kg solution to tube 3, and (d) 80 microL 10 mg/kg solution to tube 4. To each tube was added 8 mL malt extract agar, thereby diluting the chemical mix by 1:100. The tubes were capped and mixed by inversion. The mix from each tube was poured into a well of the culture plate, together with a plate poured from the malt extract agar with no chemical added (the control). Wells were labeled with the final concentration of chemical (0, 100, 10, 1, and 0.1 mg/kg). The procedure was repeated to make enough plates for all the molds tested and the malt extract agar was allowed to cool and solidify. After solidification, the plates were inoculated with mold as labeled. A sterile plastic loop was used to cut a small plug of agar containing mycelia growth and spores from the source petri dish with well-grown molds and the plug was transferred to a well in the 6-well plate. Each agar-filled well was inoculated with a single plug. When all wells were inoculated with indicated molds, the plates were placed in a plastic container at room temp in an incubator and growth was monitored. The minimal inhibitory concentration (MIC) was recorded as the lowest concentration of the chemical that completely inhibited growth of the mold from the plug. Mold growth on the plug but not on the agar in the well was counted as inhibition.

2. Wood Panel Test Method.

The wood panel specimens were approximately 5×3 inches (12.7×7.6 cm)×board thickness. There were seven replicates per treatment. The wood panels were conditioned at approximately 80° F. (27° C.) and 80% relative humidity for one week prior to mold inoculation. The wood panels were supported on a screen above a layer of water in a sealed plastic box for 8 weeks at approximately 80° F. (27° C.) and 100% relative humidity.

Mold and stain fungi used for inoculum were Alternaria alternata, Aspergillus niger, Aureobasidium pullulans, Cladosporium cladosporioides, and an additional mold isolated from ACQ-treated wood from Georgia Pacific (October 2002, tentatively identified as Cephalosporium sp. (DR 423).

Each inoculum was produced from fully colonized, 2% malt agar in 100 mm petri plates, by washing spores with 10 mL distilled water plus 10 mL rinse (20 mL inoculum were produced per plate). The panels were inoculated by spraying with mixed spore suspension of mold on the surface to be evaluated; approx. 2-3 mL of inoculum were applied per panel. The panel surfaces were lightly misted with distilled water once per week during the evaluation test to maintain optimum conditions for mold colonization in the chambers. Two evaluation ratings were made weekly for 8 weeks; using a scale of 0 (no coverage by mold) to 10 (total coverage by mold). Evaluation ratings included assessments of 1) coverage by mold mycelium and 2) density/discoloration by mold. A rating of 0 was considered excellent, a rating greater than 0 and less than 2 was considered good, and a rating equal to or greater than 2 was considered poor.

### EXAMPLES

ACQ solutions were prepared for use in the following examples. Ratios of copper and quaternary ammonium chloride conform to the AWPA specifications previously described above.

For ACQ-C, “Cu-count-N” solution (1000 g, a copper ammonium carbonate solution containing 8% copper as the metal, available from Mineral Research Development Company, Harrisburg N.C.) was charged into a 2000 mL three neck-round bottom flask equipped with a mechanical stirrer and a thermometer. Then 280.2 g of ethanolamine was added, portion by portion, to the flask under stirring while controlling the temperature of the exothermic mixing so as not to exceed 45° C.. After stirring for 30 min., alkylbenzyldimethylammonium chloride (50.9 g, available from Aldrich, Milwaukee Wis. as benzalkonium chloride) was added and the mixture stirred for a further 30 min.

For ACQ-D, the procedure for ACQ-C was followed except that 63.7 g of an 80% ethanolic solution of didecyldimethyammonium chloride (available from Lonza Company, Fair Lawn N.J. as DDAC) was substituted for the alkylbenzyldimethylammonium chloride.

Various diluted ACQ-C and ACQ-D solutions were made by dilution of the concentrated solution of ACQ-C and ACQ-D with deionized water.

### Examples 1-8 and Comparative Examples A-G

For each of Examples 1 to 8, two moldicides as listed in Table 2 were mixed with ACQ-C formulation in the amount indicated and tested using the Six-well Plate Test on a broad range of wood mold/mildew. For Comparative Examples A to E single moldicides were tested in the same manner. Concentrations of each moldicide are expressed in mg/kg. Test periods were for 14 and 21 days.

The tested concentrations were 0.2, 0.4, 0.8, 1.6, 3.1, 6.2, 12.5, 25, 50, 100 mg/kg each, or 0.1, 0.2, 0.4, 0.8, 1.6, 3.1, 6.2, 12.5, 25, 50 mg/kg each where two moldicides were combined. The ACQ-C formulation without moldicides was tested at 0.1, 0.01, 0.001 and 0.0001%, designated as Comparative Example F. Comparative Example G was a single moldicide plus ACQ as shown in Table 2 and was tested at the same concentrations as the single moldicides in the same manner.

The synergistic index, denoted by I, was calculated according to Kull, C. E et al., in Applied Microbiology, 9, 538-541 (1961), and extended for n ingredients (where n is 2 or more) as follows.

For a formulation of A+B . . . +N,

$$I = \sum \frac{Ca}{CA} + \frac{Cb}{CB} + … + \frac{Cn}{CN} ,$$

where:
Ca is the concentration of A at the MIC of A+B+ . . . +N,
CA is the MIC of A alone,
Cb is the concentration of B at the MIC of A+B+ . . . +N, and
CB is the MIC of B alone,
Cn is the concentration of N at the MIC of A+B+ . . . +N, and
CN is the MIC of N alone.

When I is less than 1 a synergistic effect is indicated. When I equals 1, no synergy is present. When I is greater than 1, the mixture is less active than the sum of the activities of the individual moldicides.

The resulting data are shown in Table 2. The numbers in each cell of Table 2 for Comparative Examples A-F show the MIC in mg/kg. The unbolded numbers for Comparative Example G and Examples 1-8 show the concentrations (mg/kg) for each moldicide at the MIC for that composition.

The results shown in Table 2 demonstrated that synergistic combinations of two or more moldicides are more effective in preventing mold growth. A single moldicide with ACQ was not as effective.

TABLE 2

| Ex. | Formulation | Incubation | Aspergilus | Aureobasidium | Cladosporium | Penicilium | Alternaria | Trichoderma | Stachybotrus |
|---|---|---|---|---|---|---|---|---|---|
| #* | Name | Period (days) | Niger | Pullulans | cladosporioides | funiculosum | alternata | virens | charatrum |
| A | Propiconazole | 14 | 25 | 0.8 | 3.1 | >100 | 100 | 6.2 | 25 |
| A | As above | 21 | 25 | 0.8 | 3.1 | >100 | 100 | 12.5 | 25 |
| B | Cyprodinil | 14 | 100 | 100 | 100 | 100 | 12.5 | 100 | 100 |
| B | As above | 21 | >100 | >100 | >100 | 100 | 50 | >100 | 100 |
| C | Cymoxanil | 14 | >100 | >100 | >100 | >100 | >100 | >100 | NT |
| D | Tebucanazole | 14 | 10 | 10 | 10 | >10 | 100 | >10 | NT |
| E | TCMBT | 14 | NT | 300 | 30 | 30 | 300 | 3 | |
| F | ACQ-C | 14 | 1000 | 300 | 1000 | 1000 | 1000 | 1000 | NT |
| G | Propiconazole + | | NT | 5, | 5, | 50 | 100, | 5, | NT |
| | 0.01% | | | I > 1 | I > 1 | I < 0.6 | I > 1 | I = 0.91 | |
| | ACQ | | | | | | | | |
| 1 | Propiconazole + | 14 | 6.2/6.2, | 0.1/0.1, | 1.6/1.6, | 0.1/0.1, | 25/25, | 3.1/3.1, | 1.6/1.6, |
| | cyprodinil | | I = 0.41 | I = 0.46 | I = 0.62 | I = 0.1 | I > 1 | I = 0.63 | |
| | (1:1) + 0.01% | | | | | | | | |
| | ACQ-C | | | | | | | | |
| 1 | As above | 21 | 12.5/12.5, | 0.8/0.8, | 1.6/1.6, | 25/25, | 25/25, | 6.2/6.2, | 12.5/12.5 |
| | | | I = 0.725 | I > 1 | I = 0.62 | 0.35 < I < 0.6 | I > 1 | I = 0.66 | |
| 2 | Propiconazole + | 14 | 25/25, | 0.4/0.4, | 1.6/1.6, | 0.1/0.1, | 25/25, | 3.1/3.1, | 25/25, |
| | cymoxanil | | I > 1 | I = 0.83 | I = 0.61 | I = 0.1 | 0.35 < I < 0.6 | I = 0.6 | |
| | (1:1) + 0.01% | | | | | | | | |
| | ACQ-C | | | | | | | | |
| 2 | As above | 21 | 25/25, | 0.4/0.4, | 1.6/1.6, | 3.1/3.1^{a} | 25/25, | 6.2/6.2, | 25/25 |
| | | | I > 1 | I = 0.83 | I = 0.61 | I < 0.16 | I > 1 | I = 0.6 | |
| 3 | Tebuconazole + | 14 | 6/6, | 0.75/ | 3/3, | 0.05/ | 3/3, | 6/6, | NT |
| | Cyprodinil | | I = 0.76 | 0.75, | I = 0.43 | 0.05, | I = 0.37 | I < 0.76 | |
| | (1:1) + 0.01% | | | I = 0.41 | | I = 0.1 | | | |
| | ACQ-C | | | | | | | | |
| 4 | Tebuconazole + | 14 | 12.5/ | 1.5/1.5, | 0.75/ | 0.05/ | >12.5/ | 6/6, | NT |
| | TCMBT | | 12.5, | I = 0.48 | 0.75, | 0.05, | >12.5, | I > 1 | |
| | (1:1) + 0.01% | | I > 1 | | I = 0.2 | I = 0.1 | I > 0.265 | | |
| | ACQ-C | | | | | | | | |
| 5 | Cyprodinil + TCMBT | 14 | >12.5/ | 6/6, | 6/6, | 0.05/ | 0.75/ | >12.5/ | NT |
| | (1:1) + 0.01% | | >12.5, | I = 0.4 | I = 0.36 | 0.05, | 0.75. | >12.5, | |
| | ACQ-C | | | | | I = 0.1 | I =0.185 | I > 1 | |
| 6 | Tebucanazole + | 14 | 4/4/4 | 0.5/0.5/ | 0.5/0.5/ | 0.033/ | 2/2/2, | 8.3/8.3/ | NT |
| | cyprodinil + TCMBT | | | 0.5, | 0.5, | 0.033/ | I = 0.286 | 8.3, | |
| | (1:1:1) + 0.01% | | | I = 0.39 | I = 0.17 | 0.033, | | I > 1 | |
| | ACQ-C | | | | | I = 0.1 | | | |
| 7 | Propioconazole + | 14 | 4/4/4 | 0.13/0.13/ | 0.5/0.5/ | 0.033/ | 4/4/4, | 4/4/4, | NT |
| | Cyprodinil + TCMBT | | | 0.13, | 0.5, | 0.033/ | I = 0.47 | I > 1 | |
| | (1:1:1) + 0.01% | | | I = 0.5 | I = 0.28 | 0.033, | | | |
| | ACQ-C | | | | | 1 = 0.1 | | | |
| 8 | Propiconazole + | 14 | 8.3/8.3/ | 0.27/ | 0.5/0.5/ | 0.033/ | >8/>8/>8, | 4/4/4, | NT |
| | Tebucanazole + | | 8.3, | 0.27/ | 0.5, | 0.033/ | I > 0.9 | I > 1 | |
| | TCMBT | | I > 1 | 0.27, | I = 0.33 | 0.033, | | | |
| | (1:1) + 0.01% | | | I = 0.67 | | I = 0.1 | | | |
| | ACQ-C | | | | | | | | |

^{a}slow growth
NT = not tested

### Examples A-G are Comparative Examples

### Examples 9-17 and Comparative Examples H-P

Compositions for treating wood panels were prepared as follows: moldicides were added to 1% of ACQ-D solution and stirred until solution was complete. Table 3 lists the resulting compositions used for treatment of wood. The numbers in parentheses indicate the weight ratio of the first listed moldicide to the second listed moldicide.

TABLE 3

| | | Concentration |
|---|---|---|
| | | of Total |
| | | Moldicide, |
| Ex. # | Moldicide | mg/kg |
| H | Propiconazole | 10 |
| I | Propiconazole | 20 |
| J | Propiconazole | 40 |
| K | Tebuconazole | 10 |
| L | Tebuconazole | 20 |
| M | Tebuconazole | 40 |
| 9 | Propiconazole + Tebuconazole | 20 (1:1) |
| 10 | Propiconazole + Tebuconazole | 30 (1:2) |
| 11 | Propiconazole + Tebuconazole | 40 (1:1) |
| N | TCMBT | 10 |
| O | TCMBT | 20 |
| P | TCMBT, | 40 |
| 12 | Propiconazole + TCMBT | 20 (1:1) |
| 13 | Propiconazole + TCMBT | 30 (1:2) |
| 14 | Propiconazole + TCMBT | 30 (2:1) |
| 15 | Propiconazole + Cyprodinil | 20 (1:1) |
| 16 | Propiconazole + Cyprodinil | 30 (2:1) |
| 17 | Propiconazole + Cyprodinil | 40 (1:1) |

Note:
TCMBT: 30% W/W in ethylene glycol from Buckman Laboratories, Inc., Memphis, TN.

Wood panels were treated with controls and the compositions as listed in Table 3 in the pressure lab, following a procedure based on AWPA standard. Wood panels were loaded into a 2 gallon (7.6 L) autoclave at room temperature and covered with the composition. The autoclave was sealed, evacuated under hose vacuum (about 8.7 psia, 60 10 kPa) for 15 min. and pressurized with nitrogen for 1 hour at 155 psia (1070 kPa). The solution was removed under atmosphere and the wet wood panels were returned to the vessel and vacuum for 5 min. to prevent dripping.

The treated panels were dried in the hood and tested using the Wood Panel Test Method previously detailed, based on American Society for Testing Materials (ASTM) standards, as described in Laks, P. E., Richter, D. L., and Larkin, G. M., “Fungal susceptibility of interior commercial building panels”, Forest Products Journal, 52(5), 41-44, 2002. The resulting data are shown in Table 4.

TABLE 4

| | | Total | | | | | | | | | |
|---|---|---|---|---|---|---|---|---|---|---|---|
| | | Moldicide | | | | | | | | | |
| | | Concn., | | | | | | | | | |
| | | mg/kg, | | | | | | | | | |
| | Treatment Soln. | (Ratio of | | | | | | | | | |
| | Active | 1^{st} to 2^{nd} | Test Duration, weeks | | | | | | | | |
| EX. # | ingredient(s) | moldicide) | 1 | 2 | 3 | 4 | 5 | 6 | 7 | 8 | Rating |
| J | Propiconazole | 40 (N/A) | 0 | 0 | 0 | 0 | 0 | 0 | 0 | 0 | Excellent |
| 9 | Propiconazole + Tebuconazole | 20 (1:1) | 0 | 0 | 0 | 0 | 0 | 0 | 0 | 0 | Excellent |
| 11 | Propiconazole + Tebuconazole | 40 (1:1) | 0 | 0 | 0 | 0 | 0 | 0 | 0 | 0 | Excellent |
| 12 | Propiconazole + TCMBT | 20 (1:1) | 0 | 0 | 0 | 0 | 0 | 0 | 0 | 0 | Excellent |
| 13 | Propiconazole + TCMBT | 30 (1:2) | 0 | 0 | 0 | 0 | 0 | 0 | 0 | 0 | Excellent |
| 16 | Propiconazole + Cyprodinil | 30 (2:1) | 0 | 0 | 0 | 0 | 0 | 0 | 0 | 0 | Excellent |
| 17 | Propiconazole + Cyprodinil | 40 (1:1) | 0 | 0 | 0 | 0 | 0 | 0 | 0 | 0 | Excellent |
| 15 | Propiconazole + Cyprodinil | 20 (1:1) | 0 | 0 | 0 | 0 | 0.1 | 0 | 0.1 | 0.1 | Good |
| M | Tebuconazole | 40 (N/A) | 0 | 0 | 0.1 | 0.1 | 0.1 | 0.1 | 0.3 | 0.3 | Good |
| 10 | Propiconazole + Tebuconazole | 30 (1:2) | 0 | 0 | 0.1 | 0.3 | 0.6 | 0.7 | 0.7 | 0.9 | Good |
| O | TCMBT | 20 (N/A) | 0 | 0 | 0.1 | 0.4 | 0.9 | 1 | 1.3 | 1.4 | Good |
| 14 | Propiconazole + TCMBT | 30 (2:1) | 0 | 0 | 0 | 0.1 | 0.4 | 0.9 | 1.1 | 1.7 | Good |
| K | Tebuconazole | 10 (N/A) | 0 | 0 | 0.4 | 1.1 | 1.9 | 2.3 | 2.4 | 2.7 | Poor |
| N | TCMBT | 10 (N/A) | 0 | 0.3 | 1.3 | 2.1 | 2.4 | 2.9 | 3.1 | 3.3 | Poor |
| P | TCMBT | 40 (N/A) | 0 | 0 | 0.3 | 0.9 | 1.6 | 2.1 | 2.6 | 3.3 | Poor |
| L | Tebuconazole | 20 (N/A) | 0 | 0.3 | 1.6 | 3.4 | 4.7 | 5.7 | 5.7 | 5.9 | Poor |
| I | Propiconazole | 20 (N/A) | 0 | 1.4 | 4.6 | 6.4 | 7.6 | 8 | 8 | 8.1 | Poor |
| H | Propiconazole | 10 (N/A) | 0.1 | 1.3 | 5 | 7.3 | 8.6 | 9.3 | 9.4 | 9.9 | Poor |
| Control A | Untreated | N/A | 4.4 | 6.7 | 7.7 | 9.0 | 9.3 | 9.3 | 9.4 | 9.4 | Poor |
| Control B | 1% ACQ-D | N/A | 0 | 0 | 0 | 0.3 | 1.7 | 3.0 | 3.9 | 4.3 | Poor |

Note:
Weekly ratings:
0 = no coverage by mold stain.
10 = total coverage by mold stain.
Ratings:
0 is Excellent,
>0 and <2 is Good,
=/>2 is Poor.

Based on these results, the compositions with the single moldicide propiconazole or tebuconazole at 40 mg/kg showed good potential to control mold growth. Compositions having a combination of propiconazole with tebuconazole, TCMBT or cyprodinil showed good potential to control mold growth on ACQ treated wood at a concentration of 20 mg/kg total moldicide.

For example, 10 mg/kg each of propiconazole and TCMBT, 10 mg/kg each of propiconazole and tebuconazole, and 10 mg/kg each of propiconazole and cyprodinil all allowed effective control of Alternaria alternata, Aspergillus niger, Aureobasidium pullulans, Cladosporium cladosporioides and an additional mold isolate tentatively identified as Cephalosporium sp. (DR 423) isolated from ACQ treated wood from Georgia Pacific 10/02.

1. A composition comprising a copper compound, a quaternary ammonium compound, an alkanolamine or ammonia, a carbonate, and at least two moldicides wherein the total concentration of moldicides is a maximum of 80 mg/kg, said composition effective to prevent mold growth in pressure treated wood.

2. The composition of claim 1 wherein the moldicides are a first moldicide which is a triazole and at least one additional moldicide.

3. The composition of claim 2 wherein the first moldicide is a triazole and the additional moldicide is selected from the group consisting of cis-trans-1-[2-(2,4-dichlorophenyl)-4-propyl-1,3-dioxolan-2-ylmethyl]-1H-1,2,4-triazole(propiconazole); (RS)-1-p-chlorophenyl-4,4-dimethyl-3-(1H-1,2,4-triazol-1-ylmethyl)pentan-3-ol(tebuconazole); 4-cyclopropyl-6-methyl-N-phenylpyrimidin-2-amine(cyprodinil); and 2-(thiocyanomethylthio)benzothiazole (TCMBT).

4. The composition of claim 3 wherein the moldicides are cis-trans-1-[2-(2,4-dichlorophenyl)-4-propyl-1,3-dioxolan-2-ylmethyl]-1H-1,2,4-triazole(propiconazole) and (RS)-1-p-chlorophenyl4,4-dimethyl-3-(1H-1,2,4-triazol-1-ylmethyl)pentan-3-ol(tebuconazole).

5. The composition of claim 3 wherein the moldicides are cis-trans-1-[2-(2,4-dichlorophenyl)-4-propyl-1,3-dioxolan-2-ylmethyl]-1H-1,2,4-triazole(propiconazole) and 2-(thiocyanomethylthio)benzothiazole (TCMBT).

6. The composition of claim 3 wherein the moldicides are cis-trans-1-[2-(2,4-dichlorophenyl)-4-propyl-1,3-dioxolan-2-ylmethyl]-1H-1,2,4-triazole(propiconazole) and 4-cyclopropyl-6-methyl-N-phenylpyrimidin-2-amine(cyprodinil).

7. The composition of claim 3 wherein the moldicides are (RS)-1-p-chlorophenyl-4,4-dimethyl-3-(1H-1,2,4-triazol-1-ylmethyl)pentan-3-ol(tebuconazole) and 2-(thiocyanomethylthio)benzothiazole (TCMBT).

8. The composition of claim 3 wherein the moldicides are (RS)-1-p-chlorophenyl-4,4-dimethyl-3-(1H-1,2,4-triazol-1-ylmethyl)pentan-3-ol(tebuconazole) and 4-cyclopropyl-6-methyl-N-phenylpyrimidin-2-amine(cyprodinil).

9. The composition of claim 3 wherein the moldicides are (RS)-1-p-chlorophenyl-4,4-dimethyl-3-(1H-1,2,4-triazol-1-ylmethyl)pentan-3-ol(tebuconazole), 4-cyclopropyl-6-methyl-N-phenylpyrimidin-2-amine(cyprodinil) and 2-(thiocyanomethylthio)benzothiazole (TCMBT).

10. The composition of claim 3 wherein the moldicides are cis-trans-1-[2-(2,4-dichlorophenyl)-4-propyl-1,3-dioxolan-2-ylmethyl]-1H-1,2,4-triazole(propioconazole), 4-cyclopropyl-6-methyl-N-phenylpyrimidin-2-amine(cyprodinil) and 2-(thiocyanomethylthio)benzothiazole (TCMBT).

11. The composition of claim 3 wherein the moldicides are cis-trans-1-[2-(2,4-dichlorophenyl)-4-propyl-1,3-dioxolan-2-ylmethyl]-1H-1,2,4-triazole(propiconazole), (RS)-1-p-chlorophenyl-4,4-dimethyl-3-(1H-1,2,4-triazol-1-ylmethyl)pentan-3-ol(tebuconazole), 2-(thiocyanomethylthio)benzothiazole (TCMBT).

12. The composition of claim 1 wherein the total concentration of moldicides is from about 5 to about 60 mg/kg.

13. The composition of claim 1 wherein the total concentration of moldicides is from about 10 to about 40 mg/kg.

14. The composition of claim 1 wherein the total concentration of moldicides is a maximum of about 20 mg/kg.

15. A method of preserving wood comprising contacting pressure treated wood with the composition of claim 1.

16. A method of preserving wood comprising contacting pressure treated wood with the composition of claim 3.

17. A method of improving an ACQ formulation for treating wood against mold comprising adding to the ACQ formulation at least two moldicides wherein the total concentration of moldicides is a maximum of 80 mg/kg.

18. The method of claim 17 wherein the total concentration of moldicides is from about 5 to about 60 mg/kg.

19. The method of claim 17 wherein the total concentration of moldicides is from about 10 to about 40 mg/kg.

20. The method of claim 17 wherein the moldicides are selected from the group consisting of cis-trans-1-[2-(2,4-dichlorophenyl)-4-propyl-1,3-dioxolan-2-ylmethyl]-1H-1,2,4-triazole(propiconazole), (RS)-1-p-chlorophenyl-4,4-dimethyl-3-(1H-1,2,4-triazol-1-ylmethyl)pentan-3-ol(tebuconazole), 4-cyclopropyl-6-methyl-N-phenylpyrimidin-2-amine(cyprodinil) and 2-(thiocyanomethylthio)benzothiazole (TCMBT).

21. The method of claim 20 wherein the moldicides are cis-trans-1-[2-(2,4-dichlorophenyl)-4-propyl-1,3-dioxolan-2-ylmethyl]-1H-1,2,4-triazole(propiconazole) and 2-(thiocyanomethylthio)benzothiazole (TCMBT).

22. The method of claim 20 wherein the moldicides are (RS)-1-p-chlorophenyl-4,4-dimethyl-3-(1H-1,2,4-triazol-1-ylmethyl)pentan-3-ol(tebuconazole) and 2-(thiocyanomethylthio)benzothiazole (TCMBT).
